(19) United States
(12) Patent Application Publication
(10) Pub. No.: US 2011/0234477 A1
(43) Pub. Date: Sep. 29, 2011

(54) ORGANIC LIGHT EMITTING DEVICE, LIGHTING APPARATUS, DISPLAY APPARATUS AND METHOD FOR MANUFACTURING THE ORGANIC LIGHT EMITTING DEVICE

(75) Inventors: Junji SANO, Yokohama-shi (JP); Masato Sawada, Yokohama-shi (JP); Naoaki Sakurai, Yokohama-shi (JP)

(73) Assignee: KABUSHIKI KAISHA TOSHIBA, Tokyo (JP)

(21) Appl. No.: 13/004,323

(22) Filed: Jan. 11, 2011

(30) Foreign Application Priority Data
Mar. 23, 2010 (JP) 2010-065914

(51) Int. Cl. G09G 3/30; H01J 1/62

(52) U.S. Cl. 345/77; 313/504

(57) ABSTRACT

According to one embodiment, an organic light emitting device includes: a base material having flexibility; an organic light emitting element provided on the base material; and a protection film that covers the organic light emitting element. The protection film includes: a first inorganic layer that is provided on the organic light emitting element, and covers the organic light emitting element; a flexible layer that is provided on the first inorganic layer, contains an organic polymer, and has flexibility; and a second inorganic layer that is provided on the flexible layer, and covers the flexible layer.

### CROSS REFERENCE TO RELATED APPLICATIONS AND INCORPORATION BY REFERENCE

This application is based upon and claims the benefit of priority from prior Japanese Patent Application P2010-065914 filed on Mar. 23, 2010; the entire contents of which are incorporated by reference herein.

### FIELD

Embodiments described herein relate generally to an organic light emitting device, a lighting apparatus, a display apparatus and a method for manufacturing the organic light emitting device.

### BACKGROUND

When an organic light emitting element such as an organic electroluminescence (EL) element is exposed to moisture, a dark spot as a non-light emitting portion occurs in the organic light emitting element concerned owing to a deterioration of an electrode material and an organic material. Growth of this dark spot decreases light emission brightness of the organic light emitting element, and decreases a lifetime thereof. In order to prevent entrance of the moisture into the organic light emitting element, in usual, a method has been used, in which a drying agent is arranged on glass opposite to the organic light emitting element, and the organic light emitting element is sealed by a resin seal. Such sealing is performed by a thin film in order to obtain desired flexibility.

Meanwhile, in recent years, in order to realize thinning, weight reduction and flexibility of the organic light emitting element, a flexible substrate such as a plastic substrate has been used as a substrate for providing the organic light emitting element thereon. In the case of using this flexible substrate, it is necessary that a protection film as such a sealing thin film not only have high moisture resistance but also have stable flexibility against bend. An inorganic film such as a silicon nitride film for use as a protection film for a semiconductor or the like is capable of obtaining high moisture resistance by increasing a film thickness thereof more than 1 μm.

However, the organic film having the film thickness larger than 1 μm as mentioned above cannot obtain sufficient flexibility, and when the protection film is bent, a crack occurs in the protection film concerned. Meanwhile, when the inorganic film is thinned to an extent not to cause the crack, the moisture resistance of the protection film is decreased. Therefore, it is difficult to strike a balance between the moisture resistance and the flexibility. Accordingly, in order to obtain the desired flexibility while maintaining the moisture resistance, sealing by stacking an organic thin film and an inorganic thin film on each other has been proposed. In this sealing by the stack of the thin films, an organic thin film and an inorganic thin film, which are thinned to an extent so as not to cause the crack, are stacked on each other, whereby the protection film is composed.

However, though the flexibility is enhanced to some extent by the above-mentioned sealing by the stack of the thin films, it is necessary to compose the protection film by adopting a multi-layer configuration having four or more thin films stacked to compose the protection film concerned in order to obtain desired moisture resistance. Therefore, the number of stacked thin films which compose the protection film is increased, whereby the flexibility is decreased, and in addition, since the number of manufacturing steps is increased, productivity is decreased.

### BRIEF DESCRIPTION OF THE DRAWINGS

FIG. 1 is a cross-sectional view showing a schematic configuration of an organic light emitting device according to a first embodiment.

FIG. 2 is an enlarged cross-sectional view enlargedly showing a part of the organic light emitting device shown in FIG. 1.

FIG. 3 is a first process cross-sectional view for explaining a manufacturing process of the organic light emitting device shown in FIG. 1.

FIG. 4 is a second process cross-sectional view.

FIG. 5 is a third process cross-sectional view.

FIG. 6 is a first process cross-sectional view for explaining another manufacturing process of the organic light emitting device shown in FIG. 1.

FIG. 7 is a plan view for explaining the manufacturing process shown in FIG. 6.

FIG. 8 is a second process-cross sectional view.

FIG. 9 is a cross-sectional view showing a schematic configuration of an organic light emitting device according to a second embodiment.

FIG. 10 is a plan view showing a schematic configuration of the organic light emitting device shown in FIG. 9.

FIG. 11 is a first process cross-sectional view for explaining a manufacturing process of the organic light emitting device shown in FIG. 9.

FIG. 12 is a second process cross-sectional view.

FIG. 13 is a cross-sectional view showing a schematic configuration of an organic light emitting device according to a third embodiment.

FIG. 14 is a block diagram showing a schematic configuration of a lighting apparatus according to a fourth embodiment.

FIG. 15 is a block diagram showing a schematic configuration of a display apparatus according to a fifth embodiment.

### DETAILED DESCRIPTION

In general, according to one embodiment, an organic light emitting device includes: a base material having flexibility; an organic light emitting element provided on the base material; and a protection film that covers the organic light emitting element. The protection film includes: a first inorganic layer that is provided on the organic light emitting element, and covers the organic light emitting element; a flexible layer that is provided on the first inorganic layer, contains an organic polymer, and has flexibility; and a second inorganic layer that is provided on the flexible layer, and covers the flexible layer.

A description is made of first to fifth embodiments with reference to the drawings.

### First Embodiment

A description is made of the first embodiment of the present invention with reference to the drawings.

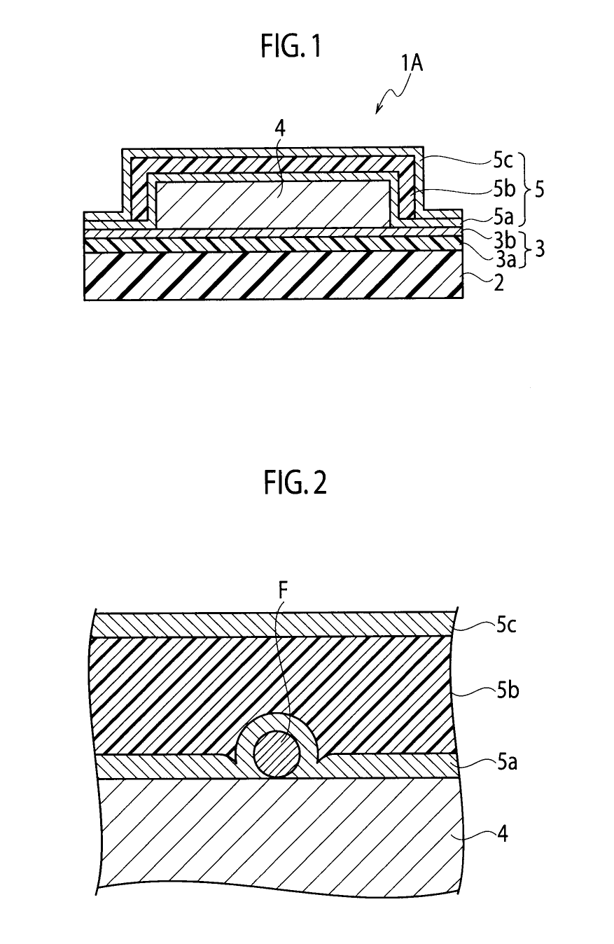

As shown in FIG. 1, an organic light emitting device 1A according to the first embodiment includes: a base material 2 having flexibility; a protection film 3 provided on the base material 2; an organic light emitting element 4 provided on the protection film 3; and a protection film 5 that covers the organic light emitting element 4.

The base material 2 is a flexible base material having flexibility. As this base material 2, for example, a resin substrate such as a polyethylene naphthalate (PEN) or polyethylene terephthalate (PET) substrate is used.

The protection film 3 is composed of: a flexible layer 3a provided on the base material 2; and an inorganic layer 3b provided on this flexible layer 3a. The protection film 3 is an insulating layer, and is provided between the base material 2 and the organic light emitting element 4 in the case where moisture resistance of the base material 2 is not sufficient. In such a way, moisture is prevented from entering the organic light emitting element 4 from the base material 2.

The flexible layer 3a is a layer containing an organic polymer and having flexibility. The flexibility of the flexible layer 3a is enhanced by the organic polymer. A thickness of the flexible layer 3a is, for example, 25 μm, and preferably, is 1 μm or more to 50 μm or less in order to enhance the flexibility and the moisture resistance. As the flexible layer 3a, there is used a silica film, an alumina film, a titania film or a zirconia film, which contains the organic polymer. The silica film is formed, for example, by baking tetraethoxyorthosilicate (TEOS) containing the organic polymer.

The inorganic layer 3b is a layer having high moisture resistance. A thickness of the inorganic layer 3b is, for example, 0.5 μm, and preferably, 1 μm or less in order to enhance the flexibility. As the inorganic layer 3b, for example, a silicon nitride (SiN) film or the like is used.

The organic light emitting element 4 is composed of a first electrode, a light emitting layer, a second electrode and the like. The light emitting layer is stacked and sandwiched between the first electrode and the second electrode, and when a current is applied between the first electrode and the second electrode, the light emitting layer emits light. As this organic light emitting element 4, for example, an organic electroluminescence (EL) element or the like is used.

The protection film 5 is composed of: an inorganic layer 5a provided on the organic light emitting element 4; a flexible layer 5b provided on the inorganic layer 5a; and an inorganic layer 5c provided on the flexible layer 5b. This protection film 5 is an insulating layer, and is provided on the base material 2 so as to cover the organic light emitting element 4. In such a way, moisture is prevented from entering the organic light emitting element 4.

The inorganic layer 5a is a layer that has high moisture resistance and covers the organic light emitting element 4. A thickness of the inorganic layer 5a is, for example, 0.5 μm, and preferably, is 1 μm or less in order to enhance the flexibility. As the inorganic layer 5a, for example, a silicon nitride (SiN) film or the like is used. This inorganic layer 5a functions as a first inorganic layer.

The flexible layer 5b is a layer containing an organic polymer and having flexibility. The flexibility of the flexible layer 5b is enhanced by the organic polymer. A thickness of the flexible layer 5b is, for example, 25 μm, and preferably, is 1 μm or more to 50 μm or less in order to enhance the flexibility. As the flexible layer 5b, there is used a silica film, an alumina film, a titania film, a zirconia film or the like, which contains the organic polymer. The silica film is formed, for example, by baking tetraethoxyorthosilicate (TEOS) containing the organic polymer.

The inorganic layer 5c is a layer that has high moisture resistance and covers the flexible layer 5b. A thickness of the inorganic layer 5c is, for example, 0.5 μm, and preferably, is 1 μm or less in order to enhance the flexibility. As the inorganic layer 5c, for example, a silicon nitride (SiN) film or the like is used. In particular, the inorganic layer 5c completely covers the flexible layer 5b, and prevents an end portion of the flexible layer 5b from being exposed to the outside. In such a way, moisture can be surely suppressed from entering the organic light emitting element 4 from the outside through the flexible layer 5b. This inorganic layer 5c functions as a second inorganic layer.

The flexible layer 5b also functions as a planarization layer that planarizes the inorganic layer 5c. For example, as shown in FIG. 2, even if an impurity F (an adherend in a previous step, for example, dust and a foreign object) is adhered onto a surface of the organic light emitting element 4, the inorganic layer 5c is planer by the presence of the flexible layer 5b.

For example, in the case where the inorganic layer 5c is directly deposited on the inorganic layer 5a without the presence of the flexible layer 5b, the inorganic layer 5c is not planer to cause a curved portion owing to a protruding portion of the inorganic layer 5a by the impurity F. Moisture is prone to enter the organic light emitting element 4 from this curved portion, and the moisture resistance is decreased. When the inorganic layer 5a itself or the inorganic layer 5c itself is formed thick in order to avoid such an occurrence of the curved portion, the flexibility is decreased. Hence, the inorganic layer 5a and the inorganic layer 5c are formed as thin as, for example, 1 μm or less, and accordingly, the above-mentioned curved portion inevitably occurs in the inorganic layer 5c. Moisture enters an inside of the organic light emitting device 1A from the vicinity of a root of the protruding portion, which is this curved portion.

Accordingly, the above-mentioned flexible layer 5b is provided on the inorganic layer 5a to a thickness to an extent to bury the protruding portion of the inorganic layer 5a, which is caused by the impurity F, whereby the flexible layer 5b absorbs irregularities of the inorganic layer 5a, and a surface (surface opposite with the organic light emitting element 4 side) of the flexible layer 5b is planer. As a result, the inorganic layer 5c provided on such a planer surface of the flexible layer 5b also is planer, a curved portion is prevented from occurring in the inorganic layer 5c, and accordingly, the moisture resistance of the inorganic layer 5c can be suppressed from being decreased. Note that, even in the case where the impurity F is adhered onto a surface of the inorganic layer 5a, the flexible layer 5b absorbs irregularities of the impurity F on the inorganic layer 5a, and the surface (surface opposite with the organic light emitting element 4 side) of the flexible layer 5b is planer. In such a way, the curved portion is prevented from occurring in the inorganic layer 5c as mentioned above, and accordingly, the moisture resistance of the inorganic layer 5c can be suppressed from being decreased.

Next, a description is made of a manufacturing method of the above-mentioned organic light emitting device 1A.

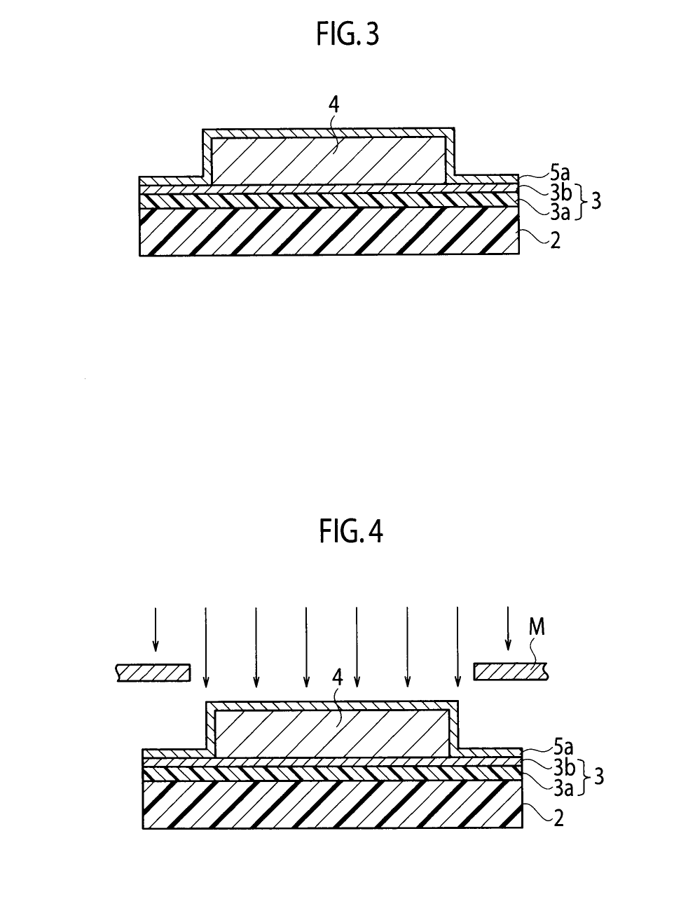

As shown in FIG. 3, first, the protection film 3, that is, the flexible layer 3a and the inorganic layer 3b are provided on the base material 2 such as the PEN substrate, and the organic light emitting element 4 is provided on a substantial center of a surface of the inorganic layer 3b. Thereafter, on the base material 2 on which the organic light emitting element 4 is provided, the inorganic layer 5a is provided so as to cover the organic light emitting element 4.

In detail, the flexible layer 3a is provided by being formed on the entire surface of the base material 2, for example, by a coating method such as spray coating. As other coating methods, there are mentioned spin coat coating, ink jet coating, dispenser coating, barcode coating, gravure coater coating, die coater coating, screen print coating, and the like. Moreover, the inorganic layer 3b is provided by being formed on the entire surface of the flexible layer 3a on the base material 2, for example, by a forming method such as plasma CVD. As other forming methods, for example, there are mentioned sputtering, vacuum evaporation, electron beam evaporation, ion plating, catalytic CVD and the like.

The organic light emitting element 4 is formed by sequentially stacking the first electrode, the light emitting layer and the second electrode on the inorganic layer 3b, and is provided on the protection film 3. Moreover, in a similar way to the inorganic layer 3b, the inorganic layer 5a is also provided by being formed on the entire surface above the base material 2 so as to completely cover the organic light emitting element 4 above the base material 2, for example, by the forming method such as the plasma CVD.

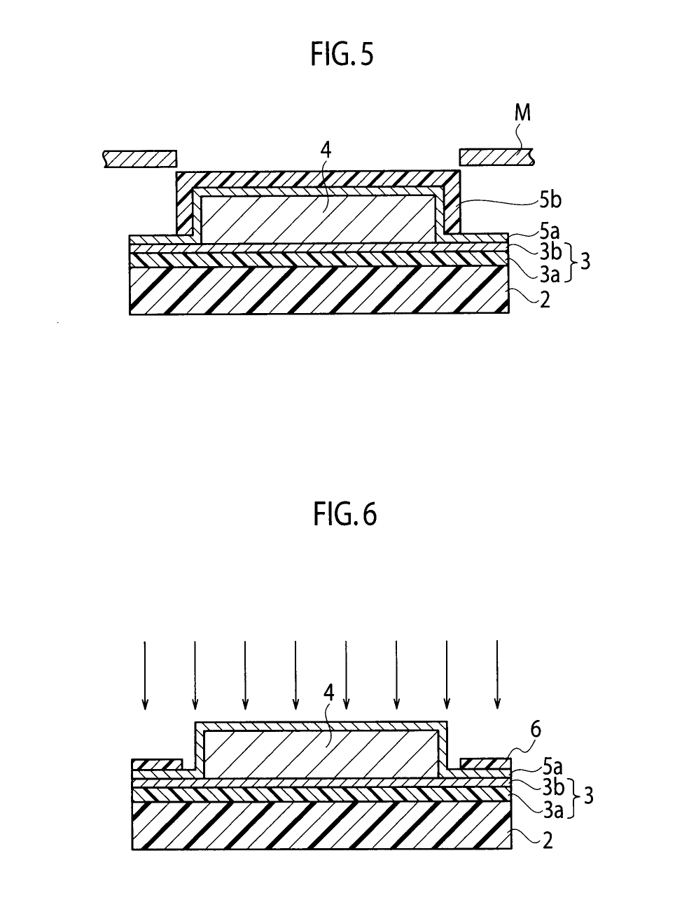

Subsequently, as shown in FIG. 4, a mask M is positioned, and the material for forming the flexible layer 5b is coated by using the mask M concerned. The mask M is a mask for forming the flexible layer 5b only on a predetermined region (for example, a predetermined region that covers the organic light emitting element 4) on the inorganic layer 5a. In such a way, as shown in FIG. 5, the flexible layer 5b is formed on the predetermined region on the inorganic layer 5a. Finally, the inorganic layer 5c is provided on the flexible layer 5b so as to completely cover the flexible layer 5b concerned. In such a way, the organic light emitting device 1A shown in FIG. 1 is completed.

In detail, the flexible layer 5b is provided by being formed on the predetermined region of the inorganic layer 5a so as to cover the organic light emitting element 4, for example, by the spray coating using the mask M. As other coating methods, there are mentioned spin coat coating, ink jet coating, dispenser coating, barcode coating, gravure coater coating, die coater coating, screen print coating, and the like. Moreover, in a similar way to the above-mentioned inorganic layer 3b and inorganic layer 5a, the inorganic layer 5c is provided by being formed on the entire surface above the base material 2 so as to completely cover the flexible layer 5b above the organic light emitting element 4, for example, by the forming method such as the plasma CVD.

Here, as the flexible layer 3a and the flexible layer 5b, for example, the silica films containing the organic polymer, or the like are used. As a generation material of the silica films or the like, for example, tetraethoxyorthosilicate (TEOS) containing the organic polymer is used. This tetraethoxyorthosilicate containing the organic polymer is coated by being sprayed on the entire surface above the base material 2 and on the predetermined region of the inorganic layer 5b, followed by heating and baking. Then, a condensation reaction occurs, and the silica films containing the organic polymer are formed.

In usual, the organic light emitting element 4 is deteriorated by heat (for example, heat at a temperature of approximately 100° C.). However, in the case of using the silica films, which contain the organic polymer, as the flexible layer 3a and the flexible layer 5b, it is possible to form the flexible layer 3a and the flexible layer 5b at a temperature, for example, as low as approximately 80° C. Therefore, such a heat deterioration of the organic light emitting element 4 during the generation of the flexible layer 3a and the flexible layer 5b can be suppressed. Hence, it is preferable to use the silica films, which contain the organic polymer, as the flexible layer 3a and the flexible layer 5b.

Moreover, for example, the silicon nitride (SiN) films or the like are used as the inorganic layer 3b, the inorganic layer 5a and the inorganic layer 5c. In the case of using the silicon nitride films as the inorganic layer 3b, the inorganic layer 5a and the inorganic layer 5c, it is possible to deposit the inorganic layer 3b, the inorganic layer 5a and the inorganic layer 5c at a temperature, for example, as low as approximately 60° C. Therefore, the heat deterioration of the organic light emitting element 4 during the deposition of the inorganic layer 3b, the inorganic layer 5a and the inorganic layer 5c can be suppressed. Hence, it is preferable to use the silicon nitride films as the inorganic layer 3b, the inorganic layer 5a and the inorganic layer 5c.

Next, a description is made of another manufacturing method different from the above-mentioned manufacturing method.

First, in the same way as in the above-mentioned manufacturing method, the protection film 3, that is, the flexible layer 3a and the inorganic layer 3b are provided on the base material 2, and the organic light emitting element 4 is provided on the substantial center of the surface of the inorganic layer 3b. Thereafter, on the base material 2 on which the organic light emitting element 4 is provided, the inorganic layer 5a is provided so as to cover the organic light emitting element 4 (refer to FIG. 3).

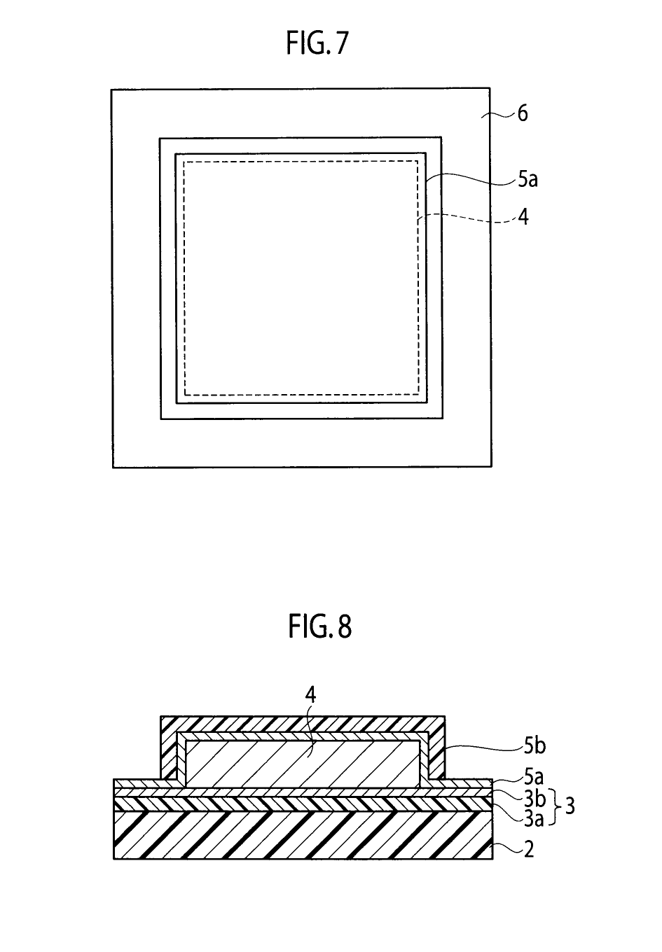

Subsequently, as shown in FIG. 6 and FIG. 7, on the inorganic layer 5a, a limiting layer 6 is provided in a frame shape surrounding the organic light emitting element 4, and thereafter, the material for forming the flexible layer 5b is coated. The limiting layer 6 is a layer for forming the flexible layer 5b only on the predetermined region (for example, the predetermined region that covers the organic light emitting element 4) on the inorganic layer 5a. After the flexible layer 5b is formed, the limiting layer 6 is removed. In such a way, as shown in FIG. 8, the flexible layer 5b is formed on the predetermined region on the inorganic layer 5a. Finally, the inorganic layer 5c is provided on the flexible layer 5b so as to completely cover the flexible layer 5b concerned. In such a way, the organic light emitting device 1A shown in FIG. 1 is completed.

In detail, the limiting layer 6 is provided on the inorganic layer 5a while forming the frame shape so as to surround the organic light emitting element 4 apart from the organic light emitting element 4 concerned by a predetermined distance. The limiting layer 6 is a layer that limits a generating region, that is, mounting region of the flexible layer 5b onto the inorganic layer 5a. For example, a water-repellent layer (liquid-repellent layer) such as a silane coupling agent is used as the limiting layer 6. This water-repellent layer is made from a material capable of repelling the material for forming the flexible layer 5b. After the flexible layer 5b is formed, the limiting layer 6 becomes unnecessary, and accordingly, is removed. By using the limiting layer 6 as described above, it is possible to limit the mounting region of the flexible layer 5b, and accordingly, the flexible layer 5b can be accurately provided on a desired region on the inorganic layer 5a.

Moreover, the flexible layer 5b is formed on the mounting region on the inorganic layer 5a, which is limited by the limiting layer 6, for example, by a spray coating and is then provided on the predetermined region of the inorganic layer 5a so as to cover the organic light emitting element 4. As other coating methods, there are mentioned ink jet coating, dispenser coating, barcode coating, gravure coater coating, die coater coating, screen print coating, and the like.

Here, a flexibility evaluation was performed for a protection film that includes a flexible layer without the organic polymer and the protection film (protection film 3 or protection film 5) that includes the flexible layer (flexible layer 3a or flexible layer 5b) containing the organic polymer.

First, on a polyethylene naphthalate (PEN) substrate, a protection film (silica film) with a first configuration described below or a protection film (silica film containing the organic polymer) with a second configuration described below was formed, and thereafter, the PEN substrate was bent, and a state of the protection film was evaluated. Note that a thickness of the PEN substrate was 200 μm. Moreover, on such a resultant, a silicon nitride (SiN) film was formed by the plasma CVD, and the flexible layer was formed thereon by the spray coating, followed by baking in the ambient atmosphere under conditions where a temperature was 80° C. and a baking time was 1 hour.

The first configuration has a stack structure of SiN (thickness: 0.5 μm)/silica (thickness: 25 μm)/SiN (thickness: 0.5 μm), and the second configuration has a stack structure of SiN (thickness: 0.5 μm)/organic polymer-containing silica (thickness: 25 μm)/SiN (thickness: 0.5 μm).

In the first configuration, when the obtained protection film was bent to a curvature radius of 60 mm, a crack occurred therein. Meanwhile, in the second configuration, even when the obtained protection film was bent to a curvature radius of 1.5 mm, a crack did not occur therein, and it was confirmed that the protection film concerned had high flexibility. Hence, the flexibility of the protection film is enhanced by the organic polymer. Note that such a SiN film with a thickness of approximately 0.5 to 1.0 μm has sufficient moisture resistance performance if the SiN film has a planar surface free from a foreign object and the like. Accordingly, the irregularities are eliminated by the flexible layer 5b, whereby even a thin SiN film can obtain sufficient moisture resistance.

As described above, in accordance with the organic light emitting device 1A according to the first embodiment, the protection film 5 is composed by providing the flexible layer 5b, which contains the organic polymer, between the inorganic layer 5a and the inorganic layer 5c. In such a way, it is possible to enhance the flexibility of the inorganic layers 5a and 5c, which have high moisture resistance and low flexibility, by thinning the inorganic layers 5a and 5c concerned. In addition, it is possible to compensate the moisture resistance, which is decreased by such thinning, by the flexible layer 5b containing the organic polymer. Furthermore, the organic polymer is contained in the flexible layer 5b, whereby the flexibility of the flexible layer 5b is enhanced. From these facts, the flexibility can be enhanced while maintaining the moisture resistance. In addition, the organic polymer is contained in the flexible layer 5b, whereby it is possible to reduce the number of layers in the protection film 5 more than in the conventional case. In such a way, the number of manufacturing steps is reduced, and accordingly, productivity of the organic light emitting device 1A can be enhanced.

Moreover, even in the case where the base material 2 is a base material such as a plastic substrate of which moisture resistance is not sufficient, then on the base material 2 concerned, the protection film 3 just needs to be composed of the flexible layer 3a and the inorganic layer 3b. In such a way, in a similar way to the above, it is possible to enhance the flexibility of the inorganic layer 3b, which has high moisture resistance and low flexibility, by thinning the inorganic layer 3b concerned, and in addition, it is possible to compensate the moisture resistance, which is decreased by such thinning, by the flexible layer 3a containing the organic polymer. Furthermore, the organic polymer is contained in the flexible layer 3a, whereby the flexibility of the flexible layer 3a is enhanced. From these facts, the flexibility can be enhanced while maintaining the moisture resistance. In addition, the organic polymer is contained in the flexible layer 3a, whereby it is possible to reduce the number of layers in the protection film 3 more than in the conventional case. In such a way, the number of manufacturing steps is reduced, and accordingly, the productivity of the organic light emitting device 1A can be enhanced.

### Second Embodiment

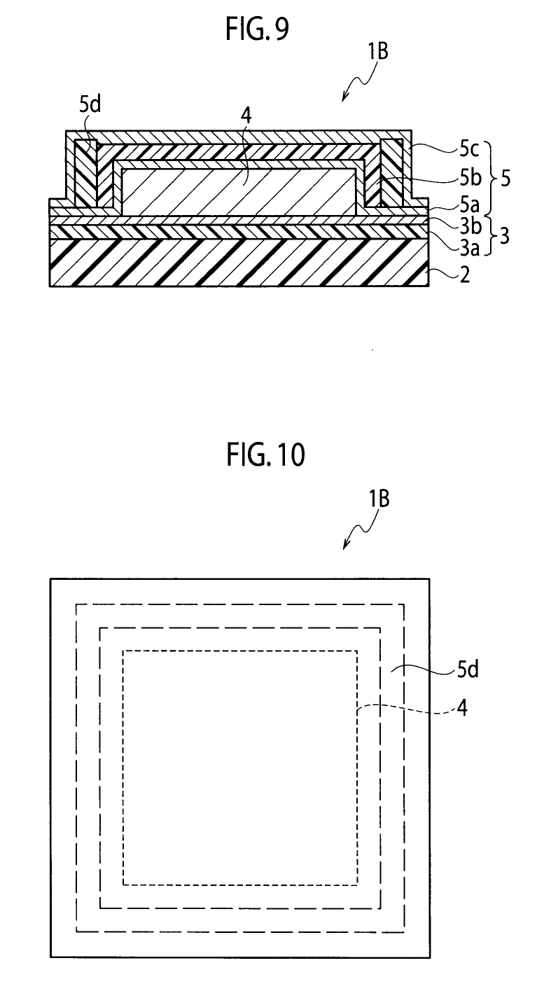

A description is made of a second embodiment with reference to FIG. 9 to FIG. 12.

The second embodiment is basically the same as the first embodiment. In the second embodiment, a description is made of different points thereof from the first embodiment. The same portions as the portions described in the first embodiment are denoted by the same reference numerals, and a description thereof is omitted.

As shown in FIG. 9 and FIG. 10, in an organic light emitting device 1B according to the second embodiment, a limiting layer 5d is provided on the inorganic layer 5a. This limiting layer 5d is a layer for forming the flexible layer 5b only on a predetermined region (for example, a predetermined region that covers the organic light emitting element 4) on the inorganic layer 5a.

In detail, the limiting layer 5d is a layer that is provided on the inorganic layer 5a in a frame shape (refer to FIG. 10) so as to surround the organic light emitting element 4, and limits a forming region, that is, mounting region of the flexible layer 5b onto the inorganic layer 5a. This limiting layer 5d has flexibility, and functions as a part of the protection film 5. The material of the flexible layer 5b is supplied to an inner region surrounded by the limiting layer 5d. At this time, the limiting layer 5d is a sidewall that functions as a dam damming the material of the flexible layer 5b. For example, a resist film or the like is used as the limiting layer 5d. By using the limiting layer 5d as described above, it is possible to limit the mounting region of the flexible layer 5b, and accordingly, the flexible layer 5b can be accurately provided on a desired region on the inorganic layer 5a.

Next, a description is made of a manufacturing method of the above-mentioned organic light emitting device 1B.

First, in the same way as in the manufacturing method of the organic light emitting device 1A according to the first embodiment, the protection film 3, that is, the flexible layer 3a and the inorganic layer 3b are provided on the base material 2, and the organic light emitting element 4 is provided on the substantial center of the surface of the inorganic layer 3b. Thereafter, on the base material 2 on which the organic light emitting element 4 is provided, the inorganic layer 5a is provided so as to cover the organic light emitting element 4 (refer to FIG. 3).

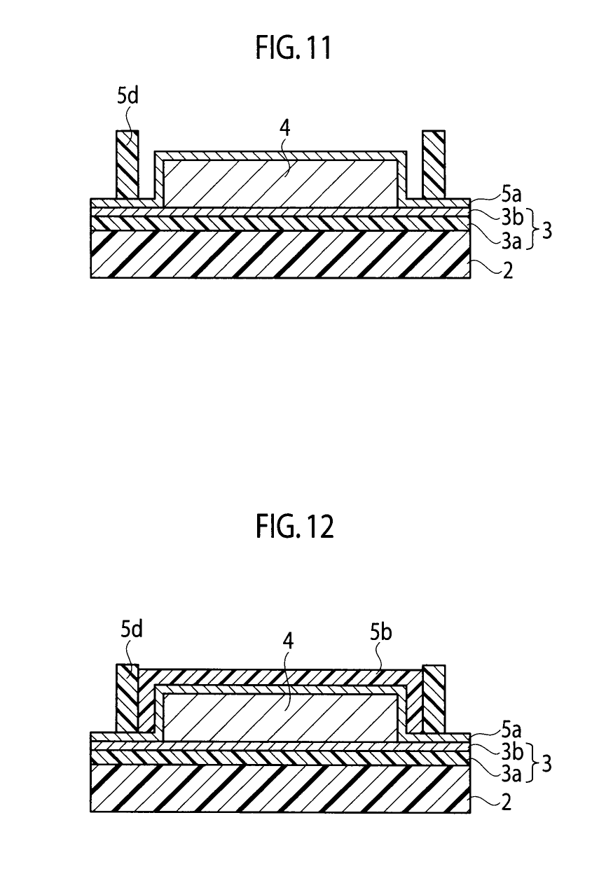

Subsequently, as shown in FIG. 11, on the inorganic layer 5a, the limiting layer 5d is provided in the frame shape surrounding the organic light emitting element 4, and thereafter, the material for forming the flexible layer 5b is coated to be supplied to the inner region surrounded by the limiting layer 5d having the frame shape. In such a way, as shown in FIG. 12, the material of the flexible layer 5b is filled into the inner region surrounded by the limiting layer 5d having the frame shape, and the flexible layer 5b is formed on the predetermined region on the inorganic layer 5a. Finally, the inorganic layer 5c is provided on the flexible layer 5b so as to completely cover the flexible layer 5b concerned. In such a way, the organic light emitting device 1B shown in FIG. 9 is completed.

As described above, in accordance with the organic light emitting device 1B according to the second embodiment, similar effects to those of the first embodiment can be obtained. Moreover, in comparison with the case of removing the limiting layer 6 after the flexible layer 5b is formed in the first embodiment, it is not necessary to remove the limiting layer 5d, the number of manufacturing steps is reduced, and accordingly, the productivity can be enhanced.

### Third Embodiment

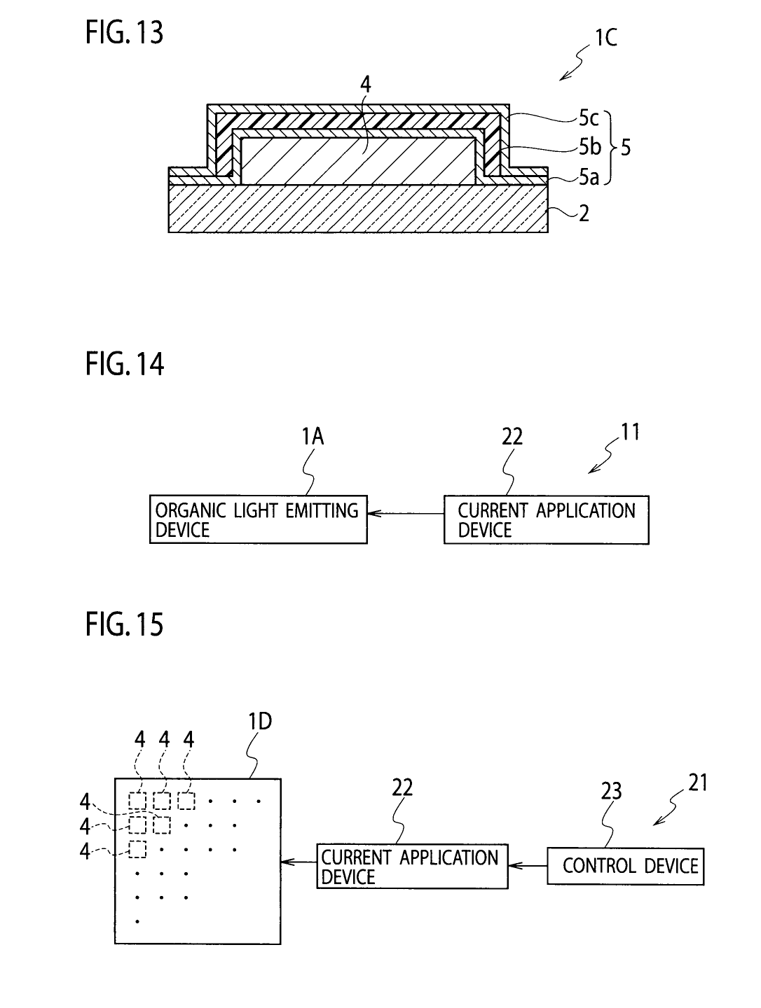

A description is made of a third embodiment with reference to FIG. 13.

The third embodiment is basically the same as the first embodiment. In the third embodiment, a description is made of different points thereof from the first embodiment. The same portions as the portions described in the first embodiment are denoted by the same reference numerals, and a description thereof is omitted.

As shown in FIG. 13, in an organic light emitting device 1C according to the third embodiment, the base material 2 is a base material having desired moisture resistance in addition to the flexibility, and the organic light emitting element 4 and the protection film 5 are directly provided on the base material 2 concerned. As the base material 2, for example, a glass substrate having high moisture resistance is used, and moisture is prevented from entering the organic light emitting element 4 from the base material 2. Note that the glass substrate is formed so that a thickness thereof can be a thickness to an extent to obtain desired flexibility.

As described above, in accordance with the organic light emitting device 1C according to the third embodiment, similar effects to those of the first embodiment can be obtained. Moreover, in comparison with the first embodiment, the number of layers generated on the base material 2 is reduced, the number of manufacturing steps is reduced, and accordingly, the productivity can be enhanced.

### Fourth Embodiment

A description is made of a fourth embodiment with reference to FIG. 14.

As shown in FIG. 14, a lighting apparatus 11 according to a fourth embodiment includes: the organic light emitting device 1A according to the first embodiment; and a current application device 22 that applies a current to the organic light emitting device 1A concerned. Note that the organic light emitting device 1B according to the second embodiment or the organic light emitting device 1C according to the third embodiment may be provided in place of the organic light emitting device 1A according to the first embodiment.

For example, one or a plurality of the organic light emitting devices 1A are provided. The number of organic light emitting devices 1A is determined in response to a desired light quantity. The current application device 22 applies the current to the organic light emitting elements 4 which the organic light emitting device 1A includes. By such current application, the organic light emitting elements 4 emit light, and the lighting apparatus 11 irradiates light.

As described above, in the lighting apparatus 11 according to the fourth embodiment of the present invention, the organic light emitting device 1A according to the first embodiment (or the organic light emitting device 1B according to the second embodiment or the organic light emitting device 1C according to the third embodiment) is used, whereby the moisture resistance and the flexibility are enhanced, and a brightness deterioration, an apparatus breakage and the like are prevented, and accordingly, apparatus reliability can be enhanced. Moreover, since the productivity is also enhanced, cost reduction can be realized.

### Fifth Embodiment

A description is made of a fifth embodiment with reference to FIG. 15.

As shown in FIG. 15, a display apparatus 21 according to the fifth embodiment of the present invention includes: an organic light emitting device 1D provided with a plurality of the organic light emitting elements 4; the current application device 22 that applies currents individually to the respective organic light emitting elements 4 of the organic light emitting device 1D concerned; and a control device 23 that controls the current application device 22.

The organic light emitting device 1D includes, as pixels for displaying an image, the plurality of organic light emitting elements 4, for example, arranged in a matrix. Specifically, these organic light emitting elements 4 are provided in the matrix on the inorganic layer 3b (refer to FIG. 15), and the inorganic layer 5a is provided on all of these organic light emitting elements 4 so as to cover all of the organic light emitting elements 4. In a similar way, the flexible layer 5b is provided on a predetermined region on the inorganic layer 5a so as to cover all of the organic light emitting elements 4, and the inorganic layer 5c is provided on the flexible layer 5b so as to cover the flexible layer 5b concerned.

Hence, the organic light emitting device 1D according to the fifth embodiment is a device having a structure in which the plurality of organic light emitting elements 4 of the organic light emitting devices 1A (refer to FIG. 1) according to the first embodiment are present. Here, a similar structure to that of the organic light emitting devices 1B (refer to FIG. 9) according to the second embodiment or of the organic light emitting devices 1C (refer to FIG. 13) according to the third embodiment may be adopted, and a structure in which the plurality of organic light emitting elements 4 are provided by means of this structure may be used. Note that, in the case of adopting the structure of the organic light emitting devices 1B according to the second embodiment, the limiting layer 5d is formed on the inorganic layer 5a in a frame shape surrounding the peripheries of all of the organic light emitting elements 4 at a time.

The current application device 22 applies the currents to the respective organic light emitting elements 4 in response to control of the control device 23. The control device 23 includes a CPU, a memory and the like, and controls the current application device 22 to display an image by the respective organic light emitting elements 4 based on image data regarding the image. In such a way, the display apparatus 21 displays the image by the respective organic light emitting elements 4. Note that the image data is provided in a storage unit such as the memory included in the control device 23.

As described above, in the display apparatus 21 according to the fifth embodiment of the present invention, the organic light emitting device 1A according to the first embodiment (or the organic light emitting device 1B according to the second embodiment or the organic light emitting device 1C according to the third embodiment) is used, whereby the moisture resistance and the flexibility are enhanced, and the brightness deterioration, the apparatus breakage and the like are prevented, and accordingly, the apparatus reliability can be enhanced. Moreover, since the productivity is also enhanced, the cost reduction can be realized.

### Other Embodiments

While certain embodiments have been described, these embodiments have been presented by way of example only, and are not intended to limit the scope of the inventions. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An organic light emitting device comprising:
a base material having flexibility;
an organic light emitting element provided on the base material; and
a protection film that covers the organic light emitting element, the protection film comprising:
a first inorganic layer that is provided on the organic light emitting element, and covers the organic light emitting element;
a flexible layer that is provided on the first inorganic layer, contains an organic polymer, and has flexibility; and
a second inorganic layer that is provided on the flexible layer, and covers the flexible layer.

2. The organic light emitting device of the claim 1, wherein the protection film further comprises:
a limiting layer that is provided on the first inorganic layer so as to surround the organic light emitting element, and limits a mounting region of the flexible layer onto the first inorganic layer.

3. A lighting apparatus comprising:
an organic light emitting device comprising:
a base material having flexibility;
an organic light emitting element provided on the base material; and
a protection film that covers the organic light emitting element, the protection film comprising:
a first inorganic layer that is provided on the organic light emitting element, and covers the organic light emitting element;
a flexible layer that is provided on the first inorganic layer, contains an organic polymer, and has flexibility; and
a second inorganic layer that is provided on the flexible layer, and covers the flexible layer; and
a current application device configured to apply a current to the organic light emitting device.

4. A display apparatus comprising:
a light emitting device comprising:
a base material having flexibility;
a plurality of organic light emitting elements provided on the base material; and
a protection film that covers the organic light emitting elements, the protection film comprising:
a first inorganic layer that is provided on the organic light emitting elements, and covers the organic light emitting elements;
a flexible layer that is provided on the first inorganic layer, contains an organic polymer, and has flexibility; and
a second inorganic layer that is provided on the flexible layer, and covers the flexible layer;
a current application device configured to apply currents individually to the organic light emitting elements; and
a control device configured to control the current application device to display an image by the organic light emitting elements.

5. A method for manufacturing an organic light emitting device, comprising:
providing an organic light emitting element on a base material having flexibility;
providing a first inorganic layer on the base material so as to cover the organic light emitting element;
providing, on the first inorganic layer, a flexible layer that contains an organic polymer and has flexibility; and
providing a second inorganic layer on the flexible layer so as to cover the flexible layer.
